(19) United States
(12) Patent Application Publication
(10) Pub. No.: US 2010/0035143 A1
(43) Pub. Date: Feb. 11, 2010

(54) Lithium battery

(75) Inventors: Rui Xu, Dongguan (CN); Yong Qiang Deng, Dongguan (CN); Cheng Hua Fu, Dongguan (CN)

Correspondence Address: Dongguan Amperex Technology Co., Ltd., P.O. BOX 166-13, Taipei, Taiwan, 115, TW

(73) Assignee: Dongguan Amperex Technology Co., Ltd.

(21) Appl. No.: 12/222,247

(22) Filed: Aug. 6, 2008

(51) Int. Cl. H01M 2/02

(52) U.S. Cl. 429/164

(57) ABSTRACT

The present invention is to provide a lithium battery can be exempted from short circuit problems caused by metallic particles agitated through the manufacturing process and later usage. Said lithium battery includes a battery cover, anode films, separators, cathode films, an organic electrolyte, a cylindrical housing with a neck portion formed on an upper portion of the cylindrical housing. Said neck portion is spread with a layer of polymeric based composite materials onto an inner wall inside the neck portion, damages happened to the neck portion will not cause short circuit also.

### FIELD OF THE INVENTION

The present invention is related to a lithium battery has a safety feature, particularly to a housing of lithium battery molded into shape, metal particles of which can be exempted from short circuit.

### BACKGROUND OF THE INVENTION

Since 1990, lithium battery initially developed by Sony corporation; the same has been modified and improved hugely in decades. It is predicted that up to 1.871 billion cellular phones and 0.293 billion lap-tops will be powered by lithium ion packs before AD 2017. Due to the development of advanced electronic equipments, in a world overwhelmed by small-size, light weight, and portable electronic devices; which must be ensure by high capacity density batteries with reliable safety.

A lithium battery comprises anode films, separators, cathode films, an organic electrolyte and battery housing. The anode film is usually made of lithium cobalt oxide, nickel lithium cobalt oxide, manganese lithium oxide etc. The separator is a single or multi-layers of microporous membrane, made of polyethylene or polypropylene. The cathode film is made of graphitized carbon materials or amorphous carbon materials etc. Electric potential of the cathode films in the battery approaches to the same of lithium, which is more active and unstable in aqueous solution. Therefore a non-aqueous, non-protonic organic solvent is needed to be the carrier of lithium ions. Such an organic electrolyte may be primary, secondary, and tertiary of carbonate-mixed solvent includes ethylene carbonate, propylene carbonate, dimethyl carbonate, diethyl carbonate and methyl ethyl carbonate.

Lithium battery is commonly used in all areas; therefore the safety of a lithium battery becomes the most concerned issue. To ensure the safety of the lithium battery, various measures have been applied as following:

1. The separator is spontaneously closed when temperature is over 130° C. Since the separator is configured by a polymeric based composite porous polyethylene membrane (PE) sandwiched between two polypropylene membranes (PP) so as to form PP-PE-PP composite film. When the battery is heated up to 130° C., the expanded PE forms a hard surface product to shut up all the pores that are otherwise normally formed therethrough. An internal resistance of the battery has risen abruptly. It results in a cut-off circuit makes temperature rising curve of the battery can be leveled off to prevent the battery from overheating.

2. Adding Additives to the Electrolyte

Adding a certain monomer molecules to the electrolyte, when the battery is charged to a regulated voltage, the monomer molecules will be polymerized on a surface of the cathode film to form a conducting polymer membrane. With said conducting polymer, contact electrification between the anode film and the cathode film induced to an extent, by which a little short circuit inside the battery cuts off the charging current to prevent the battery from being overcharged. Or the battery capacity fades and self-discharges electricity gradually, thus the battery will not be over charged, such as, for example, a 100% capacity as a safe capacity threshold is retained.

In addition, adding fire retardants to the electrolyte may transfer the inflammable electrolyte into an incombustible or a self-extinguishable electrolyte. Either the exothermic reaction heat or self heating reaction of the battery can be reduced. Thermal stability of the electrolyte is improved to prevent the battery from being overcharged and blown up.

3. Enhanced Mechanisms of Battery Cover

Circuit breaker and marking (or safety grating) explosion protection structure are increased to the battery cover. When battery is charged to the regulated voltage; activation process proceeded inside the battery may generate partly air expansion. As a result, an inner pressure of the battery rising to an extent flips said battery cover upside down and circuit breaker cuts off the current of the battery. Or the inner pressure rising to an extent, stress accumulated to the marking or safety grating, which is therefore blown up and the battery starts leaking air to ensure the safety of the battery.

All measures described above may improve the safety of the lithium battery but safety problem still remains. Such as a cylindrical housing of the battery is concaved in the neck portion, when such a neck portion is shaped, some metallic particles may be generated by first rubbing down or eroding the neck portion during the manufacturing process and then the metallic particles is scattered. Said metallic particles may penetrate said separator of the battery to cause short circuit. As well-known, such penetration of metallic particles through separators ever caused laptop batteries on fire, Computer manufacturers, such as Sony had to recall those defective batteries for examination.

### SUMMARY OF THE INVENTION

The present invention is to provide a lithium battery to be exempted from short circuit phenomenon caused by penetration of metallic particles, motions of which are agitated as a neck portion of battery cylinder is processed concaved in shape during the manufacturing process as described above.

The lithium battery of the invention comprising:

A cylindrical housing of the battery, a cover, anode films, separators, cathode films and an organic electrolyte, before the cylindrical housing is extruded molded to form a neck portion concaved in shape, an inner wall of said neck portion is spread with a layer of polymeric based composite materials circular in shape.

Since the layer of polymeric based composite materials are applied inside the neck portion prior to the neck portion molded into shape. Thus, in manufacturing, said metallic particles are covered up by said layer of polymeric based composite materials, the metallic particles though still can be agitated by rubbing or eroding, but they are not going to penetrate into the housing. Short circuit problems can be reduced, and damages to the neck portion caused by rubbing or eroding process can be alleviated by the polymeric based composite materials added inside the neck portion.

### BRIEF DESCRIPTION OF THE DRAWINGS

FIG. 1: is a perspective view of the cylindrical housing before the neck portion is concaved in shape.

FIG. 2: is a cross-sectional view along line II-II of FIG. 1.

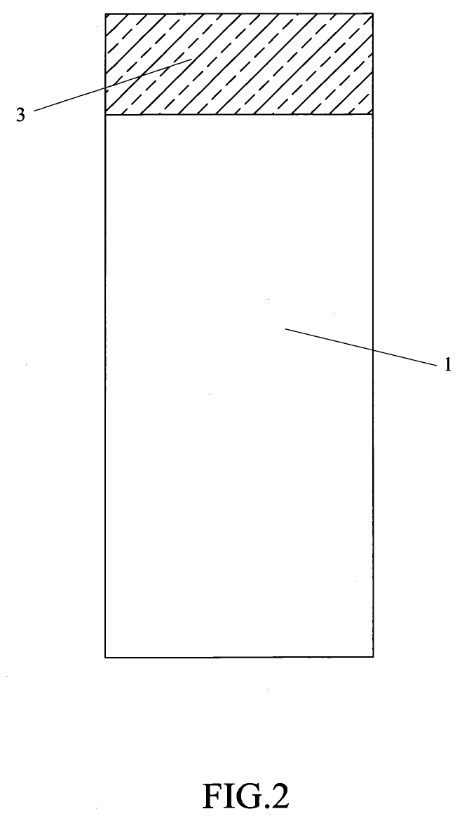

FIG. 3: is a perspective view of the cylindrical housing with neck portion.

FIG. 4: is a cross-sectional view along line IV-IV of FIG. 3

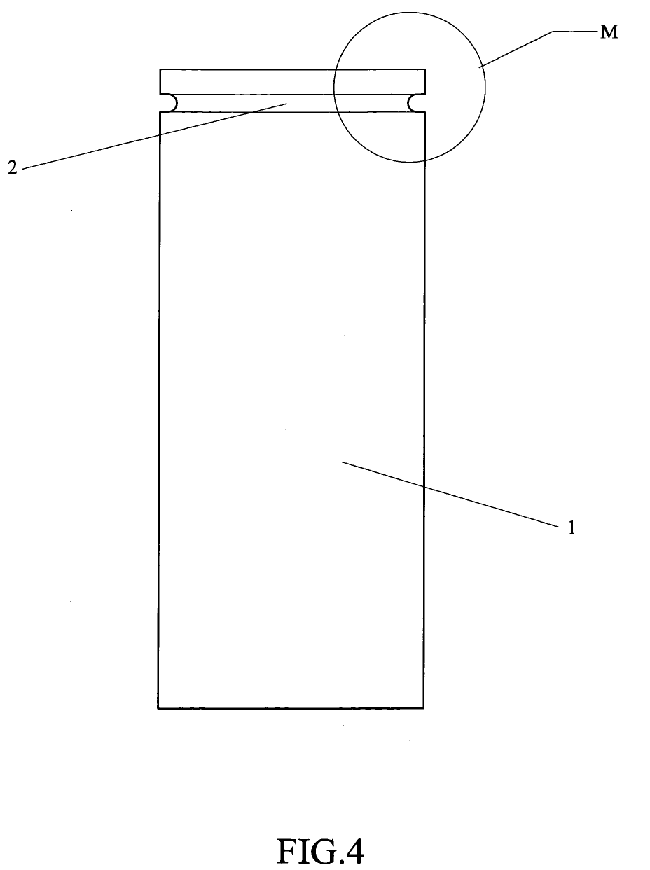

FIG. 5: is an enlarged view of the neck portion of the cylindrical housing of FIG. 4.

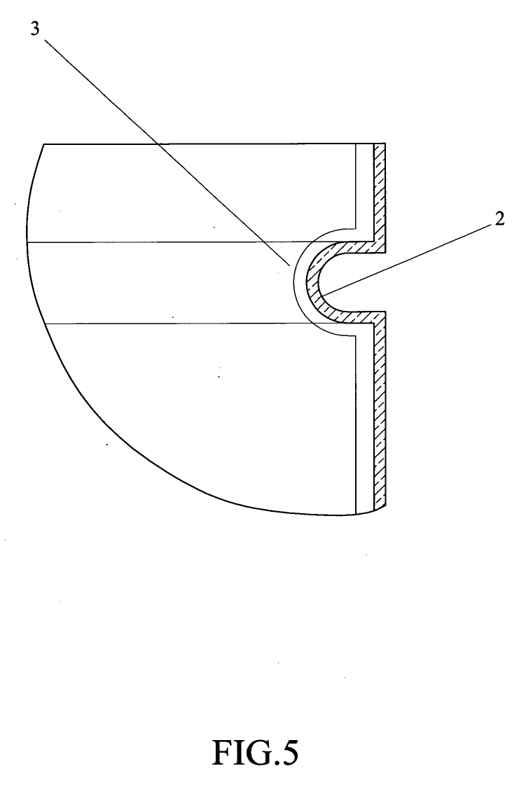

### DETAIL DESCRIPTION OF THE PREFERRED EMBODIMENT OF THE INVENTION

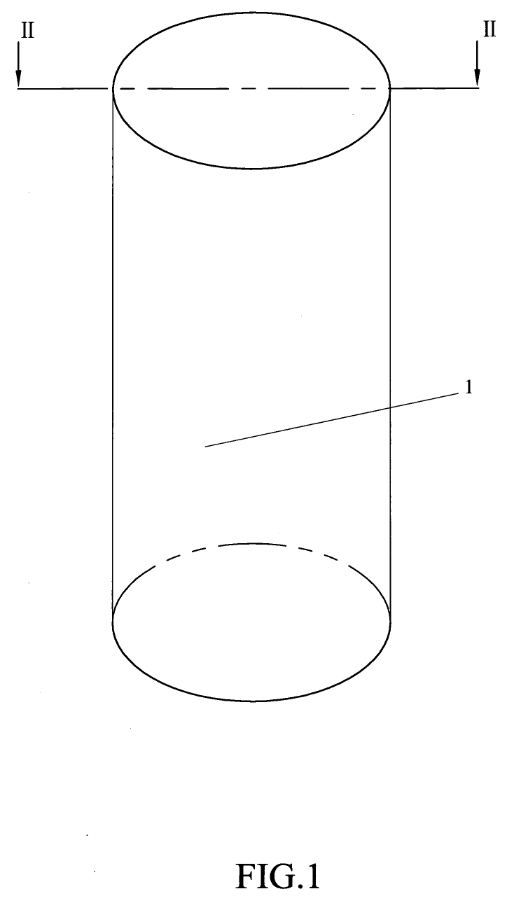

The description is described in detail according to the appended drawings hereinafter. As shown in FIG. 1˜5, a lithium battery of this invention includes a battery cylindrical housing (1), a battery cover, anode films, separators, cathode films, an organic electrolyte and a neck portion (2) concaved in shape formed around an upper portion of the cylindrical housing (1).

As shown in FIG. 1˜2, before said concaved in shape neck portion (2) is extruded molded, the cylindrical housing (1) is substantially a metallic sheet stretched in cylindrical shape processed through cold roll-forming or calendaring molding, a proximal end of which is bottomless housing open end, but a distal end will be with a partly sealed cover. Before the cylindrical housing is molded into shape, an inner wall of an upper portion of the cylindrical housing is spread with an annular layer of polymeric based composite materials (3) around the inner wall of the upper portion.

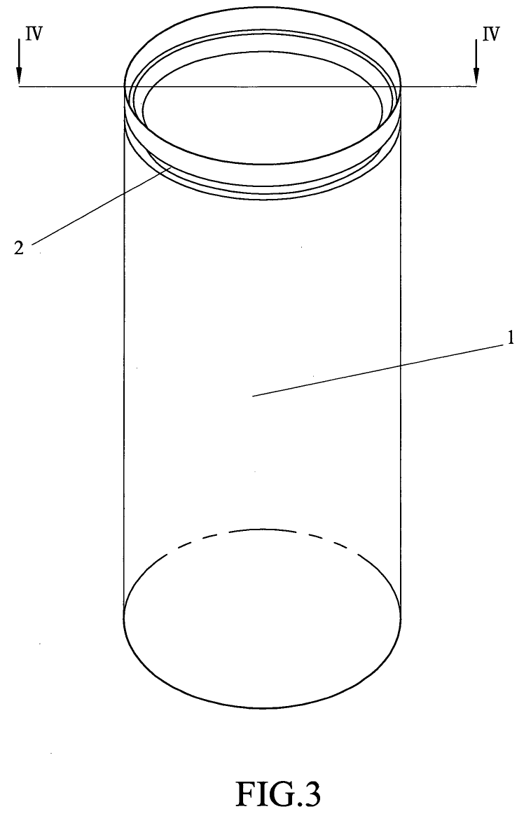

As shown in FIG. 3˜5, said neck portion (2) of the cylindrical housing (1) may be molded into shape, while a few metallic particles may be agitated and fallen therethrough, more metallic particles still are bound or clung on the metallic sheet. However, inside the annular neck portion (2), damages caused by collisions are also brought thereto. After that, when the metallic particles, which is already agitated or to be agitated, fallen or to be fallen, left and scattered into the battery, the separators may be penetrated through by the metallic particles to cause short circuit. But the annular layer of polymeric based composite materials (3) increased to the inner wall inside the neck portion (2), said polymeric based composite materials (3) may shield the agitated metallic particles from penetrating into the separators. And more metallic particles may be agitated during later usage can also be put in order before departure from the metallic sheet. Thus, short circuit problems caused by penetration of metallic particles to the separators can be prevented from happening to the cylindrical housing (1).

Before the neck portion (2) is molded into shape, the annular polymeric based composite materials can be spread on the inner wall inside the neck portion (2) close the distal end step by step as following:

1. Straight magnetic strut wrapped with clean tissues first is used to clean inner side of the cylindrical housing (1);

2. Brushes dipped within aqueous polyamide latex, which is smoothly spread about the distal end of the cylindrical housing; essentially, the inner wall inside the neck portion is thoroughly painted and coated with said polyamide latex.

3. Said cylindrical housing is further put in an oven baked for one minute, then the finished cylindrical housing can be taken out.

Said Polymeric based composite materials include but are not limited by materials as following: butyl benzene rubber, butyronitrile rubber, carboxylated acrylonitrile butadiene rubber, carboxyl chloroprene rubber, epoxide, polysiloxane, chloro-ammine ester gum, urea-formaldehyde resin adhesive, phenolic-resin adhesive, polyethylene, polypropylene, polyvinylidene chloride, polyvinyl chloride, polyvinyl acetate, polyacrylic resin and others. Aqueous polyimide latex is exemplified applied to the inner wall inside the neck portion of the present invention.

A width of the layer of polymeric based composite materials (3) is defined no less than the same of the neck portion (2); The thickness of the layer of polymeric based composite materials (3) is in a range from 0.001 mm up to 0.20 mm, while the thickness in the range of 0.03 mm˜0.0.6 mm is preferably for being added to the inner wall of the neck portion by the materials (3). The oven is in usual operated up to 85° C. to bake the cylindrical housing for one minute.

What is claim claimed:

1. A lithium battery comprising a cylindrical housing, a cover, cathode films, anode films, separators, organic electrolyte and a neck portion formed inside and around an upper portion of the cylindrical housing; a polymeric based composite layer is applied to the inner wall of the neck portion.

2. The lithium battery of claim 1 wherein a thickness of said layer of said polymeric based composite material is in the range of 0.001˜0.20 mm.

3. The lithium battery of claim 2 wherein the thickness of said layer of said polymeric based composite materials is preferably restricted in the range of 0.03˜0.06 mm.

4. The lithium battery of claim 1 wherein a width of said layer of said polymeric based composite materials is no less than the width of the recess.

5. The lithium battery of claim 1 to 4 wherein said polymeric based composite materials are selected from but not limited to the following: Butyl benzene rubber, butyronitrile rubber, carboxylated acrylonitrile butadiene rubber, carboxyl chloroprene rubber, epoxide, polysiloxane, chloro-ammine ester gum, urea-formaldehyde resin adhesive, phenolic-resin adhesive, polyethylene, polypropylene, polyvinylidene chloride, polyvinyl chloride, polyvinyl acetate, polyacrylic resin and others.

6. The lithium battery of claim 5 wherein said polymeric based composite materials are composed of mainly polyimide.
